(19) United States
(12) Patent Application Publication
(10) Pub. No.: US 2013/0297386 A1
(43) Pub. Date: Nov. 7, 2013

(54) System and Method of Interactive Consumer Marketing

(71) Applicant: Brad Steinwede, Kent, WA (US)

(72) Inventor: Brad Steinwede, Kent, WA (US)

(21) Appl. No.: 13/935,409

(22) Filed: Jul. 3, 2013

Related U.S. Application Data
(62) Division of application No. 12/363,150, filed on Jan. 30, 2009.
(60) Provisional application No. 61/063,807, filed on Feb. 5, 2008.

(51) Int. Cl. G06Q 30/02

(52) U.S. Cl. CPC G06Q 30/0277
USPC 705/12

(57) ABSTRACT

A system and method of interactive consumer marketing includes marketing channels specifically and directly focused upon particular goods or services of a sponsor for a specific time period. Interactive engagement of potential consumers necessarily results from the marketing channels and further dialog and broadcast maximizes results and return on costs, with a singular and short-term commitment.

### CROSS-REFERENCE AND PRIORITY CLAIM TO RELATED APPLICATION

To the fullest extent permitted by law, the present U.S. Non-Provisional Patent Application is a Divisional Patent Application of U.S. patent application Ser. No. 12/363,150 filed Jan. 30, 2009, currently pending, and claiming priority to and the benefit of United States Provisional patent application entitled “System and Method of Interactive Consumer Marketing,” filed on Feb. 5, 2008, on behalf of inventor Brad Steinwede, and having assigned Ser. No. 61/063,807.

### COPYRIGHT NOTICE

A portion of the disclosure of this patent document may contain material which is subject to copyright protection. The copyright owner has no objection to the facsimile reproduction by anyone of the patent document or patent disclosure as it appears in the U.S. Patent and Trademark Office patent file or records, but otherwise reserves all copyright rights whatsoever.

Additionally, this patent document may contain material which is subject to contest or competition sponsorship regulations. Therefore, because such regulations are not the focus of this document, it is anticipated that if such regulation were deemed to apply, appropriate components of the system and method of interactive consumer marketing as described herein would be conformable thereto, according to the understanding of one skilled in the art.

### TECHNICAL FIELD

The present invention relates generally to marketing methods and, more specifically, to a system and method of interactive consumer marketing encouraging repeated access and viewing of a target and/or sponsor-branded website, collecting consumer database contact information, accomplishing physical presentment of and/or emotionally engaged experience with a target/sponsor product or service, and encouraging live action media attention and broadcast focus referencing a target/sponsor, while allowing for cost-effective and short-term commitment of a target/sponsor.

### BACKGROUND OF THE INVENTION

In the United States, companies and financial entities have been reported to annually spend in excess of $1.5 billion in website advertising, and in excess of $145 billion in overall product advertising. Worldwide, undoubtedly the total of such expenditures is staggering; and the figures keep growing. In fact, according to recent reports, in the third quarter of 2008, U.S. Internet advertising rose approximately 25% as compared to the same period in 2007, totaling more than $5.2 billion.

Recognizing these costs, along with technological advancements enabling the availability of the collection and transmission of electronic data and information in many forms, businesses have developed a variety of systems and methods for utilizing electronic website accesses, or hits, as sources of consumer database information. Such database information facilitates more targeted direction of advertising materials. However, while collecting consumer information at a website can be successful, the consumer must first choose to access the site. Unfortunately, as noted above, website advertising expenditures to drive consumers to sites can be significant. Paid short text advertisements that appear alongside Internet search engine results reportedly represent the largest segment of online advertising, accounting for an estimated $8.6 billion in 2007. This manner of advertising is generally premised on the fact that if a person is performing an Internet search, there is likely some interest in the search category and therefore, perhaps the individual is more likely to click through an advertisement. However, such a manner of positioning in an attempt to influence website visitation is disadvantageous in view of the present invention.

One method that some companies utilize to draw consumers to a website is direct email. Sometimes incentives may be provided in such a direct email, wherein visit by the consumer to the website is rewarded. These methods can be effective; however, are disadvantageous in that the consumer email contact data must already be known, and so this method is ineffective in delivering unknown potential consumers to a website. Moreover, even as a method of enticing a consumer to return to a previously visited site, direct email can be disadvantageous. For example, unfortunately, many consumers have become jaded to such emails and remove the message and marketing materials without viewing or examining the accompanying literature. A further drawback is the expense and commitment necessary to maintain an active and consumer-stimulating website.

Nonetheless, for potential consumers wherein no contact information has yet been collected, other marketing channels must be utilized. For example, marketing channels such as print advertising, broadcast advertising, physical storefront display, demonstration and sampling, telephone solicitation, or the like are sometimes used. Other marketing activities may also include contest or sweepstakes sponsorship, event hosting, or the like. Each can be effective in bringing product awareness to and encouraging contact from a potential consumer; however, each is disadvantageous in view of the present invention.

Some methods utilize a first marketing channel to direct a consumer to a second marketing channel. For example, a print coupon might encourage a consumer to visit a website or a physical storefront for redemption. Similarly, an electronic coupon might encourage a consumer to visit a physical storefront location related to a particular good. These methods can realize a measure of success; however, the majority of print and electronic coupons offered remain unredeemed, and thus unsuccessful in reaching the second marketing channel via the first, thus failing to influence their targeted audiences and resulting in a disadvantageously inefficient marketing strategy.

Therefore, it is readily apparent that there is a need for a system and method of interactive consumer marketing, wherein a plurality of marketing channels are specifically and directly focused upon particular goods or services of a sponsor for a specific time period, wherein interactive engagement of a plurality of potential consumers necessarily results therefrom, and wherein further dialog, broadcast and otherwise, is encouraged thereby, thus preventing the above-discussed disadvantages.

### BRIEF SUMMARY OF THE INVENTION

Briefly described, in a preferred embodiment, the present invention overcomes the above-mentioned disadvantages and meets the recognized need for such a system and method by providing short-term and cost-effective interactive consumer marketing that encourages repeated access and viewing of a target/sponsor website, collects and builds consumer database information, enables presentation/introduction of a target/sponsor product or service to consumers, and encourages media attention and broadcast of reports referencing the target/sponsor.

According to its major aspects and broadly stated, the present invention is a system and method of interactive consumer marketing, wherein a plurality of potential consumers actually experience a product or service that perhaps otherwise would not have been considered, by virtue of a system that achieves introductory results generally and initially analogous to offering a free trial sample or the like, yet advantageously accomplishes a more far-reaching and memorable experience, breaking through the seemingly impenetrable barrier that many potential consumers erect in the face of traditional advertisements, by specifically and directly focusing consumers upon particular goods or services of a sponsor for a specific time period, wherein interactive engagement of a plurality of potential consumers, such as via physical and/or emotional interactions, necessarily results therefrom and wherein further dialog, broadcast and otherwise, maximizes results and return on costs, with a singular and short-term commitment.

More specifically, the present invention in its preferred form is a system and method of interactive consumer marketing, wherein (1) webcast issuance of a challenge engages the interest of potential consumers; (2) the challenge requires potential consumers to be present at a physical location pre-selected by the sponsor for presentation of goods and/or services, or requires potential consumers to interact with particular goods and/or services in a particular manner, irrespective of location; (3) the challenge directs a specified consumer experience with the goods and/or services of the sponsor within a specified time period; (4) the nature of the challenge encourages media event coverage and related broadcast of images and verbal identification of trademarks of the sponsor; (5) the administration of, participation in, and observation of the challenge generates repeat traffic to a host site where consumer data is collected; (6) participation in the challenge requires consumer relay of further third-party consumer contact information; (7) repeat access to the host site is further encouraged for non-challenge participants by allowing for non-participants, as well as challenge participants, to democratically determine the challenge winner; (8) the host site features a host personality to develop a relationship with potential consumers; and (9) the focus sponsor of the host site display changes each day.

A specific time feature reference is preferably incorporated in the interactive consumer marketing method of the present invention, wherein the challenge webcast commences at a particular morning time, wherein the activity required for the challenge must be completed within a specific time frame from that of the webcast, wherein the web address for the host site is derived from the specific time feature reference, and wherein the challenge winner is announced at a particular evening time, twelve hours after the challenge morning webcast.

The challenge webcast preferably occurs live and is brief, with a presenting host personality, and is delivered via a global networking system, such as the Internet, as well as via transmission to web and video-capable mobile phones. The participant entries preferably involve photographs or videos of defined content, created according to the specifics of the challenge, wherein entries must be submitted via email to the host site and to a predetermined number of third parties within the specific time constraints. Contact information must be provided by the challenge participant to facilitate confirmation of timely completion of all facets of the challenge. The specifics of each challenge may be unique to each sponsor, but will typically involve the challenge participant visiting a specific physical location or otherwise performing a particular act and taking a picture or video involving the goods or services of the sponsor either at the location or as involved in the specified act with the challenge participant and cooperative third parties. It is intended that the nature of the specifics of each challenge shall be entertaining or otherwise of interest, wherein the media event coverage would likely result, with attendant broadcast resulting in repeated visual and verbal identification of trademarks of the sponsor.

Host site traffic is repeatedly generated at least as follows: (1) viewing of morning webcast of challenge; (2) finalizing an entry; (3) reviewing and voting on challenge entrants; and (4) viewing of evening webcast of winner. In order to access certain areas of the host site, a certain minimum amount of contact information must be provided. The host site is essentially owned by a particular sponsor for one day, or twenty-four hour period. During that time period, the host site is branded with sponsor trademarks and related goods and services, and a sponsor-focused video clip cycles repeatedly. Also, timely challenge entries are uploaded to the host site, are available for selective display, and can be voted on to determine the challenge winner. The host personality is individually identifiable with the system and method of interactive consumer marketing as described herein, and is thus common across sponsors. Finally, the winner receives a predetermined prize, provided by the sponsor. Thus, positive inducement to participate in the challenge is provided by way of the chance at winning the prize, and also may be in the form of a special offer or incentive issued by the sponsor of the challenge.

The system and method of interactive consumer marketing foresees a plurality of benefits to be realized therefrom. First, each consumer challenge participant and non-participant viewer will be introduced to the sponsor's product electronically during the issuance of the challenge. Next, the physical location of the sponsor's local business presence will become known to each participant, and each participant will physically visit the sponsor's selected physical location. Of course, one skilled in the art will readily recognize that according to the goods and services of the sponsor, a physical location may not be available or appropriate, wherein any desirable location or activity may be utilized instead such that rather than physical engagement of the potential consumer, emotional engagement and/or combination thereof may be utilized to cause possession of or contact with the product or service and to generate the desirable experience and/or association that is targeted by the sponsor.

Nevertheless, according to physical or emotional engagement, each participant will be re-introduced to the sponsor's product in tangible form, and will necessarily interact with the product in some manner in completing the necessary photo or video for the challenge. Third-parties, too, will also become introduced to the sponsor's physical location, as well as to the product as they participate to assist a given challenge participant in completing the challenge. Further third-parties will additionally become introduced to the sponsor's products, at least electronically, by transmission thereto of the challenge participant's entry, according to the specific rules of the challenge. And, even more third-parties will become introduced to the sponsor and its products by media coverage and/or by their own vicarious completion of the challenge.

During the initial morning transmission, an opportunity for confirmed contact with given cellular or web service subscribers is provided, wherein such contact may be further exploited for yet further marketing tactics. In completing the challenge, various electronic technology devices are beneficially employed by participants and third-parties. Use of such devices and services, such as by a winning participant, may be a source of promotional reference for the providers. Throughout the day, the ongoing display of the challenge entries for voting assures repeated viewing of the sponsor video clip, as well as other trademark and brand identity data that is displayed at the host site. And, again, upon announcement of the winner, a concentration of traffic for yet another viewing of the sponsor materials is assured.

A sponsor, such as, for exemplary purposes only, an Armed Forces recruiter, a fast food chain, an automobile manufacturer, an airline, an insurer, or a food product brand, receives immediate consumer recognition via a plurality of marketing channels, providing vast exposure at a fraction of the cost of establishing such a number of introductions independently, and further receives valuable consumer database intelligence. Other benefits for the sponsor include an ability to directly monitor at least a portion of the success of the challenge relative to site hits and sales of goods and services during the period, and, as a result of the traffic to the host site and the attendant consumer contact data, an opportunity to cross sell other goods and services to the prospective customer.

Accordingly, a feature and advantage of the present invention is its ability to enable interactive cooperation of a plurality of marketing channels.

Another feature and advantage of the present invention is its ability to induce a consumer to access a global networking system, such as the Internet, and repeatedly view a host website.

Still another feature and advantage of the present invention is its ability to provide customers with an opportunity to experience, physically and emotionally, a sponsor's goods and/or services with a positive and memorable brand experience, even if never before considered.

Yet another feature and advantage of the present invention is its ability to provide a business with cost-efficient, short-term, high-exposure promotional advertising.

Still another feature and advantage of the present invention is its ability to enable a sponsor to monitor the number of hits to both the landing page with the challenge, as well as the number of click-throughs to other goods or services of the sponsor.

Another feature and advantage of the present invention is its ability to reduce an organization's marketing expenses and costs of data acquisition, while at the same time improving consumer awareness and creating a valuable data stream.

These and other features and advantages of the present invention will become more apparent to one skilled in the art from the following description and claims when read in light of the accompanying drawings.

### BRIEF DESCRIPTION OF THE DRAWINGS

The present invention will be better understood by reading the Detailed Description of the Preferred and Alternate Embodiments with reference to the accompanying drawing figures, in which like reference numerals denote similar structure and refer to like elements throughout, and in which:

FIG. 1 is a general flow diagram of a system and method of interactive consumer marketing, according to a preferred embodiment of the present invention;

FIG. 2 is a relational diagram of the major components of the system and method of FIG. 1; and

FIG. 3 depicts representative screen shot exemplars of user interfaces preferably associated with each step of the system of FIG. 1.

### DETAILED DESCRIPTION OF THE PREFERRED AND ALTERNATE EMBODIMENTS

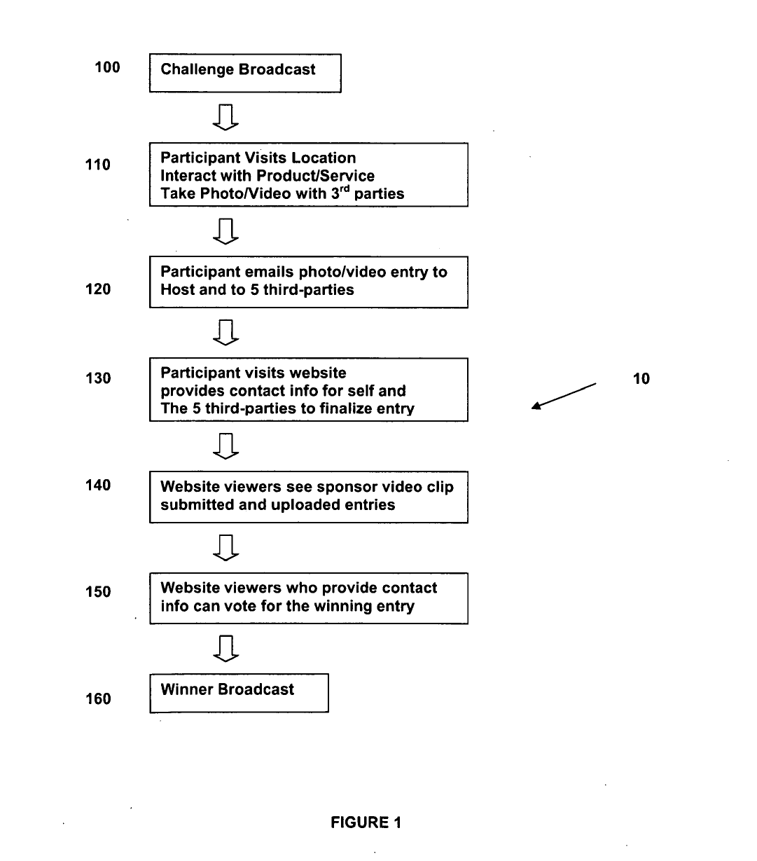

In describing the preferred and alternate embodiments of the present invention, as illustrated in FIGS. 1-3, specific terminology is employed for the sake of clarity. The invention, however, is not intended to be limited to the specific terminology so selected, and it is to be understood that each specific element includes all technical equivalents that operate in a similar manner to accomplish similar functions.

The present invention is described below with reference to flowchart illustrations of methods, apparatus (systems) and related computer program products according to embodiments of the present invention. Accordingly, blocks or steps of the flowchart illustrations support combinations of means for performing the specified functions, combinations of steps for performing the specified functions, and program instruction means for performing the specified functions. It should be recognized that any suitable flow could be utilized to effectuate the present invention without departing from the appreciative scope of the present invention, as such alternate flows are in full contemplation of the inventor in describing the present invention herein. As such, any process descriptions or blocks in the flowchart(s) should be understood as representing modules, segments, or portions which include specific functions or steps in the process, and alternate implementations are included within the scope of the present invention in which functions or steps may be executed out of order from that shown or discussed, including substantially concurrently or in reverse order, as would be understood by those reasonably skilled in the art of the present invention. Thus, merely listing or numbering the steps or blocks of a method in a certain order does not constitute any limitation on the order of the steps of that method.

Thus, in one general aspect, the system and method of interactive consumer marketing of the present invention provides for centralized database collection of specific target consumer information. Thus, the system and method of the present invention preferably defines a secure process capable of performing as a vehicle for creating a database of consumer data. Exemplary data comprise, by way of example and without limitation, names, email addresses, mailing addresses, telephone numbers, product interests, and the like. According to the preferred embodiment of the present invention, as will be further discussed hereinbelow, the database may be subdivided or categorized according to the source of engagement of the consumer interaction, the product or sponsor that was the focus of the consumer interaction, or any other reasonably useful and desirable data division.

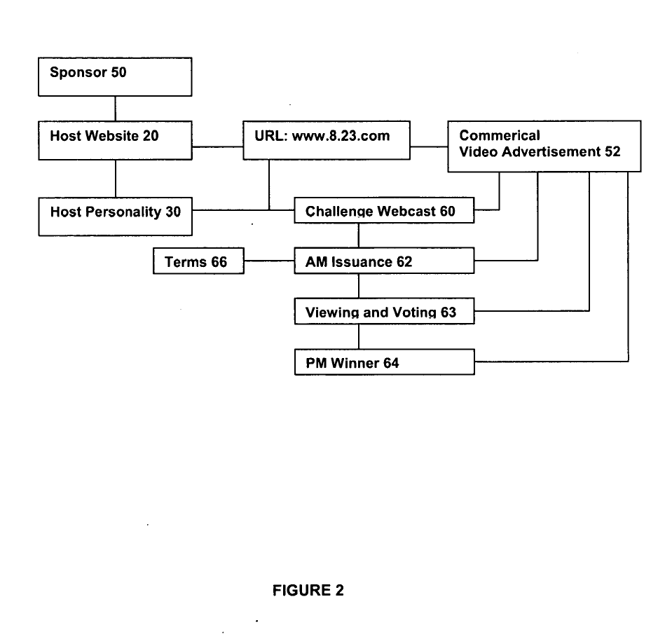

Referring now to FIG. 1, the general flow of system and method of interactive consumer marketing 10, according to a preferred embodiment of the present invention, comprises steps that occur and are completed within a twenty-four hour time span. Supportive features required for execution of system and method of interactive consumer marketing 10 preferably include host website 20, host personality 30, communication means 40, sponsor 50, and challenge 60 as represented in FIG. 2.

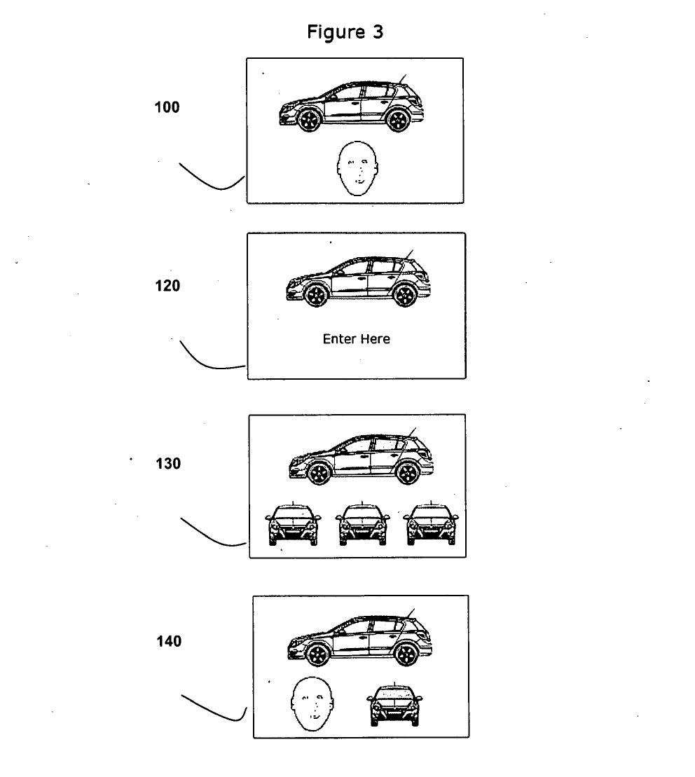

Preferably, system and method of interactive consumer marketing 10 is much like a game, stimulating the viewer and/or participant in the manner of a game show. Host website 20 is maintained via specified URL 22 on a global networking system such as the Internet. URL 22 directs the consumer to website 20, as seen in representative exemplary screenshots of FIG. 3. Website 20 is preferably non-branded other than as related to interactive marketing system and method 10, wherein preferred URL 22 is related to the specific time element of the present invention, and is for example, www.8.23.com. In such an example, URL 22 selectively represents the preferred time of the morning challenge webcast 62, 8:23 AM Pacific Time, as well as the preferred time of the evening winner webcast 64, 8:23 PM Pacific Time, as will be discussed further herein.

In the preferred embodiment, host website 20 is preferably leased to sponsor 50 for a period of one day. During the relevant twenty-four hour period, visitors to host website 20 will access an environment that is populated by the branding of sponsor 50 because host website 20 is preferably an adaptable template regularly and repeatedly uploaded with new brand information according to that day's sponsor 50. Thus, in the preferred embodiment, each day that a visitor accesses host website 20, a new sponsor's marketing materials will be displayed thereon.

Referring again to FIG. 2, the preferred system and method of interactive consumer marketing 10 begins at a specified time, wherein a five-minute live broadcast 62 is hosted by host personality 30 and is distributed via the web, at website 20, and to participating web-access mobile devices, such as mobile phones.

It should be understood by one skilled in the art that although such means of distribution are the preferred means for maximizing the benefits of system and method of interactive consumer marketing 10, any suitable communication means 40, or combination thereof, may alternately be utilized.

Preferably, as noted above, the specified time for morning webcast 62 is 8:23 am, Pacific time. This preferred time permits at least viewing of webcast 62 prior to commencement of the traditional workday, and for Eastern time zones, permits at least viewing of broadcast 62 at 11:23 am EST, just prior to the traditional lunch hour. It is envisioned that subsequent transmissions may follow around the world, according to real-times-appropriate. Thus, one skilled in the art would readily realize that while the time component is a preferred feature, any desirable time could be utilized, either with or without coordination with URL 22.

Moreover, although a five-minute presentation format is preferred for introduction of challenge 60 by host personality 30, other lengths may be utilized, either longer or shorter, as desired, without departing from the overall intended scope of the present invention. Preferably, host personality 30 sets the stage for challenge 60, building excitement for the audience prior to releasing the terms 66 of challenge 60 of sponsor 50. Then, sponsor commercial or video advertisement 52 is broadcast, wherein the subject goods or services thereof are preferably the focus of challenge 60. Host personality 30 further excites the viewers/consumers, preferably by offering a clue, or plurality of clues, and then specifies the detailed terms 66 of challenge 60, as specifically related to sponsor 50.

Thus, challenge 60 is preferably defined according to the specific sponsor 50 of host website 20 for the day the challenge 60 is issued. Nevertheless, the object of each challenge 60, irrespective of the sponsor 50, is to send in a visual confirmation via communication means 40, preferably an emailed photograph or video, showing the successful completion of the specific terms 66 of challenge 60 within the required time, preferably 120 minutes. That is, according to the preferred parameters for system and method 10, the photo/video entry must be emailed to host website 20 and to five friends by 10.23 am PST.

Exemplary terms 66 for challenge 60 that could be suitable for a particular sponsor 50 are, without limitation, as follows: (1) sponsor 50 is the U.S. ARMY and terms 66 for challenge 60 require submission of a photograph of the entrant with two friends, taken inside an ARMY recruiting office; (2) sponsor 50 is MCDONALDS and terms 66 for challenge 60 require submission of a video of the entrant with one friend eating breakfast at a MCDONALDS restaurant; (3) sponsor 50 is GENERAL MOTORS and terms 66 for challenge 60 require submission of a photograph of the entrant sitting behind the wheel of a GMC ACADIA on a GMC dealer lot; (4) sponsor 50 is TROPICANA FOODS and terms 66 for challenge 60 require submission of video of the entrant posing in a supermarket with two TROPICANA products; (5) sponsor 50 is BUDWEISER and terms 66 for challenge 60 require submission of a photo of “where do you keep your BUD?”; (6) sponsor 50 is AMERICAN AIRLINES and terms 66 for challenge 60 require submission of a video of a public display of your thoughts and affection for AMERICAN AIRLINES; or (7) sponsor 50 is GEICO and terms 66 for challenge 60 require submission of a video of your best gecko impersonation. Of course, one skilled in the art will readily recognize that the foregoing are examples without limitation, and that the sponsor/challenge terms 66 may be defined according to essentially any desired focal points and/or impact preference of each sponsor 50. Through the completion of terms 66 of each challenge 60, potential consumers are preferably (1) introduced to the physical location of sponsor 50 and/or (2) physically presented and interactive with the goods and/or services of sponsor 50. Further, depending upon the particular consumer segment that sponsor 50 is intending to engage with challenge 60, the terms 66 of challenge 60 may be more or less outlandish. It is a preferred feature of each challenge 60 that terms 66 are of such a nature that “buzz” or media attention may naturally occur as a result thereof. Such media attention further accomplishes another goal of preferred system and method of interactive consumer marketing 10, wherein broadcast and print media will further inform additional potential consumers regarding the goods or services of sponsor 50, prospectively engaging consumer interest therein, but at least garnering increased consumer awareness.

Following completion of challenge terms 66, and after email submission of an entry, each challenge participant must visit host website 20 to finalize the entry process, wherein each challenge participant must enter his/her name and email address, in addition to the name and email address of the five third-parties that were emailed the entry photo/video prior to the deadline. Further, according to the preferred format for system and method 10, each challenge participant must confirm that he/she agrees to be contacted with future offers and/or marketing materials and the like in order to qualify to win challenge 60. Still further, each entry photo/video must preferably be agreed to become the property of sponsor 50. It should be noted that alternate embodiments are envisioned wherein third-parties indirectly participating with each challenge participant would similarly render their confirmation and/or authorization to receive future offers and/or marketing materials.

Each sponsor 50 essentially “owns” host website 20 for 24 hours, wherein host website 20 is branded accordingly. Preferably, the 24-hour sponsor period begins and ends at 8:23 am PST. However, in another embodiment, it is envisioned that the sponsor period could begin and end at 9:23 pm PST, wherein the sponsor 50 for the following calendar day challenge 60 could be released the evening prior to the issuance of the challenge 60. According to this alternate embodiment, excitement and buzz could build with knowledge of the sponsor 50 and discussion regarding potential terms 66 for challenge 60 the following day. Nonetheless, either way, at least from the initial morning challenge broadcast 62, sponsor commercial/video advertisement 52 is repeatedly looped on host website 20 for a full day. Thus, after viewing the commercial/video advertisement 52 during morning challenge broadcast 62, each challenge entrant necessarily views the commercial/video advertisement 52 again while finalizing the entry.

Preferably, successful entries are displayed at host website 20, wherein any viewer may elect to view same at any time. Because commercial/video advertisement 52 loops continuously on host website 20, each such viewer is again introduced/reintroduced to the goods or services of sponsor 50. Moreover, according to the preferred embodiment of the present invention, challenge participants and non-participants alike may view and vote on the challenge entries 63 in order to select the winner. Preferably, in such manner, even more potential consumers are made aware of the goods or services of sponsor 50. However, it is preferred that appropriate tracking and verification software facilitates verification that each IP address or web-enabled phone address is limited to only one successful vote. One aspect of this process, which also strategically allows for collection of further consumer contact database information, requires provision of name and email contact data in order to vote.

Finally, and preferably at 8:23 pm PST, evening winner broadcast 64 occurs, in similar format as morning challenge broadcast 62, with host personality 30 excitedly reviewing the days events and announcing the day's challenge winner, wherein the winner preferably receives a prize from sponsor 50. Although any prize format may be utilized without departing from the intended scope of the present invention, one exemplary prize could be a cash prize. The prize commitment of sponsor 50, in addition to a sponsorship fee paid to the operators of host website 20, conforms to a desirable format with respect to investment outlay and return thereon, including product and sponsor exposure, in addition to actual direct purchases that may occur at the time or on the day of the challenge.

According to the preferred format for system and method of interactive consumer marketing 10, as exemplarily depicted in FIG. 3, host website 20 will thus be visited a minimum of four times by each challenge participant within a twelve-hour period, wherein each view will preferably be slightly different, but with the commonality of commercial/video advertisement 52 of sponsor 50, wherein at step 100, first viewing is at issuance of challenge 60; at step 130, a second viewing to complete entry; at step 150, to view other entries and vote; and, at step 160, to find out the winner. In such manner, in addition to the physical interaction and/or emotional engagement of completion of the challenge, and the undoubtedly frequent conversation of the entrant throughout the day, and even thereafter, regarding the challenge and the activities thereof, each entrant is exposed to the goods or services of sponsor 50 via a plurality of marketing channels and in a plurality of forms, and each entrant shares this knowledge, both during and likely after, the day of the challenge.

In another alternate embodiment, cameras could be strategically placed at locations related to the terms 66 of challenge 60 in order to capture the action that takes place following issuance of the challenge 60. The resulting footage could additionally populate host website 20 to generate additional interest, and could further becoming broadcast programming material, such as in the form of a weekly highlights program available on a television network, satellite, cable, webcast, or the like.

Additionally, in an alternate embodiment noted hereinabove, host website 20 could convert branding at 9:23 pm PST to the next day's sponsor 50. Such an alternate format could, for example, potentially generate sales of retail products prior to the issuance of the challenge 60 at the morning challenge webcast 62 as challenge participants attempt to anticipate the necessary “props” for completion of the next day's challenge. Another feature of such an alternate format is that the challenge 60 could require a product be photographed or video-recorded in an unexpected situation, such as, for example, on a particular mode of public transportation. Such a departure from a sponsor location could serve to expose the product and the challenge 60 issued by sponsor 50 to a further segment of the public population that may be otherwise unaware of either.

According to the preferred steps in application of system and method of interactive consumer marketing 10, as depicted in FIG. 3, as noted, step 100 occurs upon webcast issuance of a challenge 60 that engages the interest of potential consumers. Step 110 (not shown) occurs wherein the challenge 60 requires potential consumers to be present at a physical location pre-selected by the sponsor 50 for presentation of goods and/or services, and/or requires specified consumer interaction with the goods and/or services of the sponsor within a specified time period. Preferably, the nature of the activities related to Step 110 encourages media event coverage and related broadcast of images and verbal identification of trademarks of the sponsor 50. Steps 120 (not shown), 130, 140 (not shown), and 150 follow, wherein the administration of, participation in, and observation of the challenge generates repeat traffic to a host site where consumer data is collected. Steps 120 and 130 occur, wherein participation in the challenge 60 requires consumer relay of further third-party consumer contact information for Step 120, with entry confirmation at Step 130. Involvement of host website 20 at steps 100, 130, 150, and 160 generates repeat access to the host site 20 for non-challenge participants by allowing for non-participants, as well as challenge participants.

The preferred inclusion of host personality 30, along with the specific time-element feature, preferably incorporated via the webcast times and the host website URL 22, represent the preferred commonality for recognition and repeat traffic, irrespective of sponsor 50, and without detracting therefrom. That is, the preferred challenge webcast time of 8:23 am PST and winner webcast time of 8:23 pm PST is reconfirmed via the preferred URL www.8.23.com. Of course, in alternate embodiments, other time, broadcast, or URL relationships could be utilized, and the system and method of the present invention could be effectively utilized without a host personality 30.

Additionally, in alternate embodiments, additional or different consumer information could be sought and/or obtained, as desired.

Further, in another alternate embodiment, host website 20 could be a selectable element or feature of an online forum, server, access provider landing page, file sharing site, or other Internet location that may be accessed by a plurality of individuals other than those participating in system and device 10.

Again, although the description given above includes specific examples of currently envisioned embodiments of the system and method, these possibilities should not be understood as limiting the scope of the present invention but rather as providing illustrations of some of the embodiments that are now preferred. Several examples of alternate embodiments are also described and various other alternatives, adaptations, and modifications may be made within the scope of the present invention. Merely listing or numbering the steps or blocks of a method in a certain order does not constitute any limitation on the order of the steps of that method. Many modifications and other embodiments of the invention will come to mind to one skilled in the art to which this invention pertains having the benefit of the teachings presented in the foregoing descriptions and the associated drawings. Although specific terms may be employed herein, they are used in a generic and descriptive sense only and not for purposes of limitation. Accordingly, the claims that follow herein and their legal equivalents, rather than the examples given in the specification, should determine the scope of present.

Having thus described exemplary embodiments of the present invention, it should be noted by those skilled in the art that the within disclosures are exemplary only, and that various other alternatives, adaptations, and modifications may be made within the scope of the present invention. Accordingly, the present invention is not limited to the specific embodiments illustrated herein, but is limited only by the following claims.

What is claimed is:

1. A method of providing advertising, comprising the steps of:
a) obtaining a website with a domain name;
b) allowing a single sponsor to lease said website for a twenty-four hour period, wherein a lessor of said website provides a visual environment of said website for said period of said lease, and wherein said visual environment of said website is a display of said single sponsor;
c) conducting a game, wherein a component of said game is a good or a service of said sponsor, wherein each participant in said game must visit said website in a first specified time period of said period of said lease to enter said game, wherein each participant in said game must complete an act involving said good or said service component of said game, wherein each said participant must create a visual record of said act, and wherein each said participant must visit said website in a second specified time period of said period of said lease to submit said visual record of said act;
d) displaying each said submitted visual record of each said participant during a third specified time period, wherein each of a plurality of visitors to said website may cast a vote for a single said submitted visual record in, and wherein a totaling of said votes determines a winner of said game; and
e) announcing said winner of said game on said website.

2. The method of claim 1, wherein said lease period is 24 hours.

3. The method of claim 1, wherein said act involving said good or service of said sponsor further comprises interactive engagement with said good or said service.

4. The method of claim 3, wherein said interactive engagement is selected from the group consisting of physical interaction and emotional interaction.

5. The method of claim 1, wherein said game is announced in a webcast during a fourth specified time period.

6. The method of claim 1, wherein said website further comprises a host personality, wherein said host personality is consistent irrespective of sponsorship of said website.

7. The method of claim 5, wherein said fourth time period when said game is announced is during a particular morning time.

8. The method of claim 1, wherein said domain name of said website is related to said fourth time period for announcing said game.

9. The method of claim 1, wherein said announcement of said winner of said game occurs twelve hours after commencement of said game.

10. The method of claim 5, wherein said webcast is transmitted over a global networking system, such as the Internet, and over a cellular network.

11. The method of claim 1, further comprising the step of: providing said single sponsor a means to monitor at least a portion of data selected from the group consisting of site hits, consumer contact data, and click-throughs.

12. The method of claim 2, further comprising the step of: providing said single sponsor a means to monitor at least a portion of data selected from the group consisting of site hits, consumer contact data, and click-throughs.
